(19) United States
(12) Patent Application Publication
(10) Pub. No.: US 2002/0081981 A1
(43) Pub. Date: Jun. 27, 2002

(54) Panel-type speaker mounting structure

(75) Inventor: Hyun-Dong Lee, Kumi-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD, Kyungki-do (KR)

(21) Appl. No.: 09/880,672

(22) Filed: Jun. 13, 2001

(30) Foreign Application Priority Data
Dec. 14, 2000 (KR) 2000-76458

(51) Int. Cl. H04B 1/38

(52) U.S. Cl. 455/90; 455/566

(57) ABSTRACT

A panel-type speaker mounting structure is provided. In the mounting structure, an LCD window is exposed on the top end of an upper casing frame of a main body. An LCD module is disposed under the LCD window with a gap between the LCD module and the LCD window within the main body, and the LCD module has a polarizing plate divided into a first portion corresponding to the LCD window and the LCD module has a second portion extended from the first portion, for mounting a panel-type speaker.

### PRIORITY

This application claims priority to an application entitled “Panel-Type Speaker Mounting Structure” filed in the Korean Industrial Property Office on Dec. 14, 2000 and assigned Serial No.2000-76458, the contents of which are hereby incorporated by reference.

### BACKGROUND OF THE INVENTION

1. Field of the Invention

The present invention relates generally to a speaker mounting structure for a portable radio terminal, and in particular, to a panel-type speaker mounting structure.

2. Description of the Related Art

A portable radio terminal is a portable mobile station that provides radio communication services to its subscriber while wirelessly communicating with a base station. Portable terminals are classified into three different types of terminals: a bar type terminal, a flip type terminal, and a folder type terminal, according to their outer appearances. Portable radio terminals are also classified into transmission types such as ones for voice transmission, ones for transmission of pictures, and for Internet access, according to their functions. FIG. 1 illustrates a typical portable radio terminal. Referring to FIG. 1, a main body 10 of the portable radio terminal necessarily includes an antenna device 11, an upper casing frame 12, a data input device 15, a data output device 14, a transmitter 17, and a receiver 16, for communication with the other party. The data input device 15 can be a keypad including a plurality of keys or a touch screen. An LCD (Liquid Crystal Display) module is used as the data output device 14. A microphone and a speaker are usually used as the transmitter 17 and the receiver 16, respectively.

A panel-type speaker attached to a member such as a panel has recently become attractive for use as the receiver 16. The panel-type speaker is a special type of speaker that radiates sounds through the panel of a radio terminal. The panel-type speaker emits soft sounds, which are pleasing to a listener so the panel-type speaker may become widely used because it emits a pleasing soft sound.

FIG. 2 illustrates a conventional panel-type speaker mounting structure. Referring to FIG. 2, the main body 10 has an upper casing frame 12, a lower casing frame 13, an LCD (Liquid Crystal Display) module M, an LCD window 20, a panel-type speaker S and a main board B. LCD module M is mounted in an upper part of the upper casing frame 12 and transparent LCD window 20 is disposed between the LCD module M and the top end of the upper casing frame 12. That is, the LCD window 20 is on the LCD module M connected to a main board B. The LCD window 20 functions to protect the LCD module M against an external environment and is made from a transparent material, which allows a user to see displayed data. The LCD module M is comprised of a polarizing plate 18, an upper glass G1, a lower glass G2, liquid crystal L interposed therebetween upper glass G1 and lower glass G2, and a reflecting plate 19.

A panel-type speaker S is installed beneath an extended portion 20a of the LCD window 20 under a lower part of the main body 10. The LCD window 20 is larger than the LCD module M by the extended portion 20a. The panel-type speaker S is mounted to the extended portion 20a of the LCD window 20 with a gap between the panel-type speaker S and the LCD window 20.

A disadvantage with the conventional panel-type speaker is exhibited when the portable radio terminal falls onto a surface. In this case, the antenna device or the LCD window is susceptible to cracks or breakage when it falls onto a surface. Breakage of the LCD window adversely affects the underlying panel-type speaker, causing the speaker to malfunction.

### SUMMARY OF THE INVENTION

It is, therefore, an object of the present invention to provide a panel-type speaker mounting structure that is protected safely from an external environment.

The foregoing and other objects can be achieved by providing a panel-type speaker mounting structure. In a panel-type speaker mounting structure according to one aspect of the present invention, an LCD window is exposed on the top end of an upper casing frame of a main body. An LCD module is disposed under the LCD window with a gap between the LCD module and the LCD window within the main body, and the LCD module has a polarizing plate divided into a first portion corresponding to the LCD window and the LCD module has a second portion extended from the first portion, for mounting a panel-type speaker.

In a panel-type speaker mounting structure, according to another aspect of the present invention, a first LCD window is exposed on the top end of an upper casing frame of a main body. A second LCD window is disposed beneath the first LCD window and the second LCD window has a first portion corresponding to the first LCD window and the second LCD window has a second portion extended from the first portion, for mounting a panel-type speaker. An LCD module is disposed under the second LCD window within the main body.

### BRIEF DESCRIPTION OF THE DRAWINGS

The above and other objects, features and advantages of the present invention will become more apparent from the following detailed description when taken in conjunction with the accompanying drawings in which:

FIG. 1 is a plan view of a typical portable terminal;

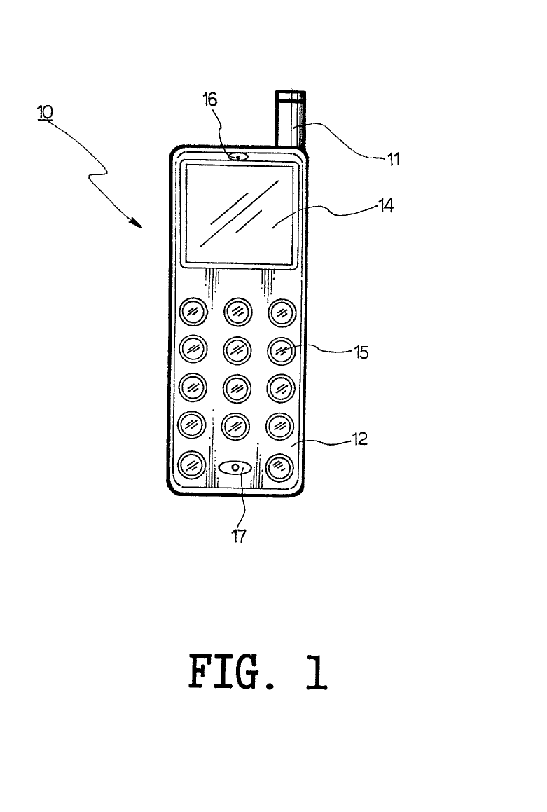

FIG. 2 is a sectional view of a conventional panel-type speaker mounting structure;

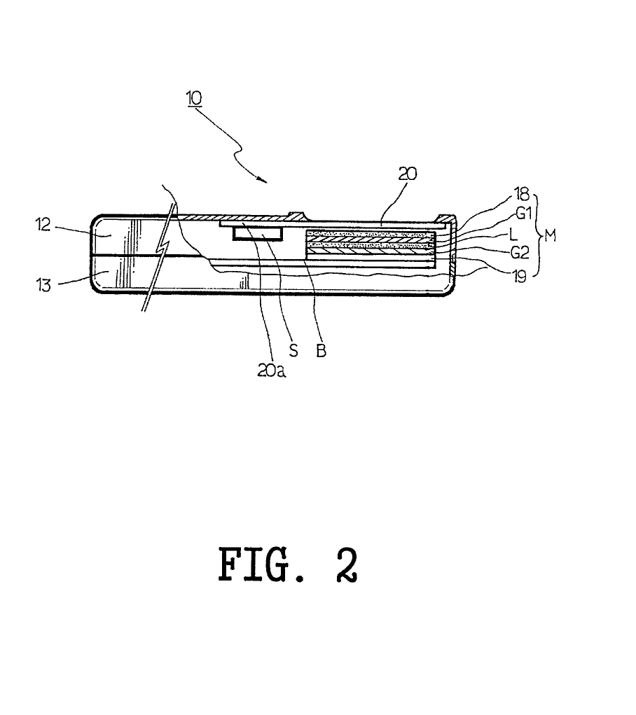

FIG. 3 is a sectional view of a panel-type speaker mounting structure, according to a preferred embodiment of the present invention; and

FIG. 4 is a sectional view of a panel-type speaker mounting structure, according to another preferred embodiment of the present invention.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail since they would obscure the invention in unnecessary detail.

While a panel-type speaker (or an exciter) according to the present invention will be described in the context of a bar-type terminal, it is a mere exemplary application and thus it is applicable to all portable radio terminals including flip type and folder type radio terminals. The panel-type speaker is a speaker that operates in a three-dimensional capacity that radiates waves around its panel and transfers sound uniformly to a listener.

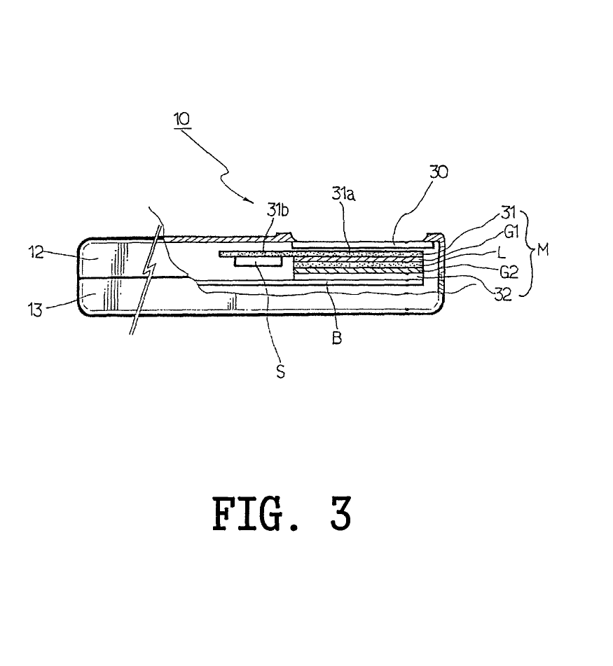

FIG. 3 is a sectional view of a panel-type speaker mounting structure according to an embodiment of the present invention. Referring to FIG. 3, the main body 10 of a portable terminal includes an upper casing frame 12, a lower casing frame 13 for protecting a main board B, LCD window 30, a panel-type speaker S, and an LCD module M. LCD window 30 is mounted on the top end of the main body 10 to protect the LCD module M. The LCD module M is comprised of a polarizing plate 31, upper glass G1, a liquid crystal L, a lower glass G2 and a reflecting plate 32. The LCD module M is mounted to the main board B under the LCD window 30.

The upper glass G1 contacts the lower glass G2 through liquid crystal L interposed therebetween the upper glass G1 and the lower glass G2. Polarizing plate 31 is disposed on the upper glass G1 and reflecting plate 32 is disposed beneath the lower glass G2. The polarizing plate 31 is made from a polarizing material and the reflecting plate 32 is made from a photosensitive material. The interior structure of the LCD module M is known to those of ordinary skill in the art.

According to the mounting mechanism of the panel-type speaker S, according to the present invention, the panel-type speaker S is installed beneath the polarizing plate 31. The polarizing plate 31 is divided into a first portion 31a and a second portion 31 b extended from the first portion 31a. The first portion 31 a is as large as the LCD window 30 and is disposed beneath the LCD window 30. This implies that the polarizing plate 31 is larger than the LCD window 30 because the second portion 31b of polarizing plate 31 provides space for mounting the panel-type speaker S. The panel-type speaker S is installed in the second portion 31b apart from the LCD window 30 by a predetermined distance, which makes the panel-type speaker S immune to shock caused when the terminal falls onto a surface terminal. In other words, since the LCD window 30 is apart from the polarizing plate 31, the panel-type speaker mounting structure protects the panel-type speaker S against shocks.

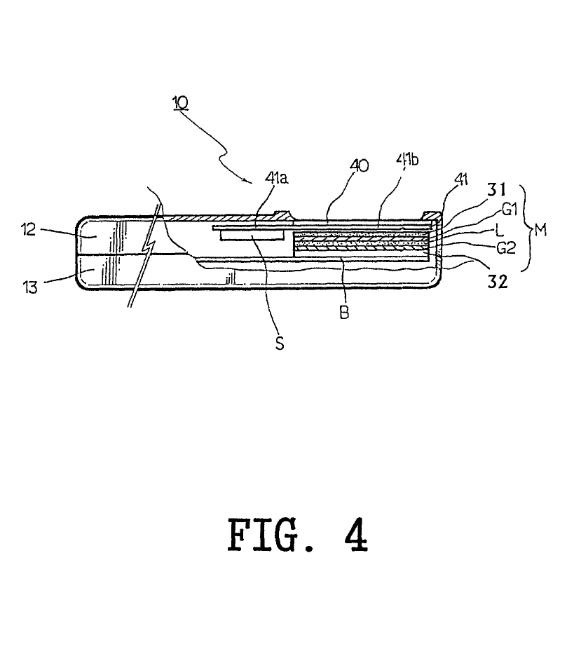

FIG. 4 is a partial sectional view of a panel-type speaker mounting structure, according to another preferred embodiment of the present invention. As shown in FIG. 4, the panel-type speaker mounting structure according to the second embodiment, is characterized by mounting the panel-type speaker S to a second LCD window 41. The first LCD window 40 is mounted on the top end of the main body 40, the second LCD window 41 is beneath the first LCD window 40, and the LCD module M connected to the main board B is under the second LCD window 41. The second LCD window 41 can be made of glass or plastic. The first LCD window 40 is as large as the LCD module M and the second LCD window 41 in contact with the first LCD window 40 is divided into a first portion 41a and a second portion 41b extended from the first portion. The second LCD window 41 is larger than the first LCD window 40 because the second portion 41b of second LCD window provides space for mounting the panel-type speaker S. The LCD module M of FIG. 4 is similar to the LCD module M of FIG. 3.

Even if the terminal main body 10 falls onto a surface, the shock is transferred indirectly to the panel-type speaker S mounted to the second portion 41b of the second LCD window 41 via the first LCD window 40. Therefore, the shock to the radio terminal is reduced. Furthermore, the panel-type speaker S also becomes immune to the shock caused by the fall, because it is located in the free end of the second portion 41b of the second LCD window 41, which does not receive the full impact of the shock.

Consequently, the panel-type speaker mounting structure, according to the present invention, is so configured as to avoid direct shock, thereby minimizing cracking or breakage of the panel-type speaker mounting portion and maintaining uniform acoustic quality.

While the invention has been shown and described with reference to certain preferred embodiments thereof, the panel-type speaker mounting structure is not limited to an extended portion of a protective panel, the double LCD windows, or installation of the panel-type speaker to the second portion of the second LCD window as far as the panel-type speaker is mounted to a portion that receives shock indirectly. For example, the panel-type speaker can be mounted to an upper/lower glass, a reflecting plate, or a main board, aside from the LCD window and the protective panel. Therefore, it is to be understood by those of ordinary skill in the art that various changes in form and details may be made therein without departing from the spirit and scope of the invention as defined by the appended claims.

What is claimed is:

1. A panel-type speaker mounting structure comprising:
an LCD window exposed on the top end of an upper casing frame of a main body; and
an LCD module disposed under the LCD window with a gap between the LCD module and the LCD window within the main body, and having a plate divided into a first portion corresponding to the LCD window and a second portion extended from the first portion, for mounting a panel-type speaker.

2. The panel-type speaker mounting structure of claim 1, wherein the second portion of the plate is extended in a predetermined direction.

3. The panel-type speaker mounting structure of claim 1, wherein the plate is made from a polarizing material.

4. A panel-type speaker mounting structure comprising:
a first LCD window exposed on the top end of an upper casing frame of a main body;
a second LCD window disposed beneath the first LCD window and having a first portion corresponding to the first LCD window and a second portion extended from the first portion, for mounting a panel-type speaker; and
an LCD module disposed under the second LCD window within the main body.

5. The panel-type speaker mounting structure of claim 4, wherein the second portion of the second LCD window is extended in a predetermined direction.

6. The panel-type speaker mounting structure of claim 4, wherein the second portion of the second LCD window is formed of one of glass, plastic, or a polarizing material.

7. The panel-type speaker mounting structure of claim 4, wherein the first LCD window is in contact with the second LCD window.

8. The panel-type speaker mounting structure of claim 4, wherein the second LCD window is spaced from the LCD module.
